(19) United States
(12) Patent Application Publication
(10) Pub. No.: US 2018/0207848 A1
(43) Pub. Date: Jul. 26, 2018

(54) INJECTION MOLDING MACHINE AND PNEUMATIC SUPPORT MECHANISM

(71) Applicant: LOTES CO., LTD., Keelung (TW)

(72) Inventor: Yung Sheng Kung, Keelung (TW)

(21) Appl. No.: 15/692,364

(22) Filed: Aug. 31, 2017

(30) Foreign Application Priority Data
Jan. 25, 2017 (CN) 201720114078.5

(51) Int. Cl. B29C 45/17; B29C 45/67

(52) U.S. Cl. CPC B29C 45/1742; B29C 45/1756; B29C 33/34; B29C 2045/6792; B29C 45/6778

(57) ABSTRACT

An injection molding machine device and a pneumatic support mechanism, the injection molding machine device includes a rack, at least one guide rail fixed to the rack, at least two guide rods, a fixed mold base fixed to one end of the rack, a movable mold base arranged opposite to the fixed mold base, at least one pneumatic support mechanism, and a cylinder. Both ends of each guide rod are fixed to the rack. The movable mold base has at least two receiving holes for receiving the guide rods, and slides on the guide rods. The pneumatic support mechanism has a lower support plate positioned above the guide rail, and an upper support plate fixed to the movable mold base. At least one accommodating cavity is arranged between the upper and lower support plates to receive the cylinder. The height of the movable mold base is adjustable by the cylinder.

### CROSS-REFERENCE TO RELATED APPLICATION

This non-provisional application claims priority to and benefit of, under 35 U.S.C. § 119(a), Patent Application No. 201720114078.5 filed in P.R. China on Jan. 25, 2017, the entire content of which is hereby incorporated by reference.

Some references, which may include patents, patent applications and various publications, are cited and discussed in the description of this disclosure, which includes, among other things, exhibits and drawings, if any. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE INVENTION

The present invention relates generally to an injection molding machine device and a pneumatic support mechanism, and more particularly to an injection molding machine device and a pneumatic support mechanism that can automatically adjust the height of a movable mold base.

### BACKGROUND OF THE INVENTION

The movable mold plate of a plastic injection molding machine has long movement stroke, and the weight of a mold base itself and the weight of a mold are very high, so a support mechanism will be arranged below a movable mold base to transfer the gravity of the movable mold base and the mold plate to an injection molding machine rack, thereby reducing the burden of mold gravity on guide rods.

A simple quick mold changing device was disclosed in Chinese Patent No. CN200820024361, in which a support mechanism for a mold is that a support positioning block is mounted below a device fixing plate and a movable mold base, and the upper positioning surface of the support positioning block is matched with the lower positioning surface of the mold to play a role of supporting the mold. The support mode belongs to a fixed support mode, and has the disadvantages that due to the manufacturing tolerance of the machine itself or the wear of a Gelin column or the support positioning block after long-time use of the machine, the movable mold base will sink or tilt relative to the fixing plate, or because the molds are not in the same horizontal plane due to the machining tolerance of the positioning surfaces of the molds themselves, the upper positioning surface of a certain support positioning block or the upper positioning surfaces of certain support positioning blocks cannot be fully matched with the lower positioning surface of a mold positioning mechanism to generate a gap. During mold opening, the gap side of the mold sinks due to the action of gravity, so that a connecting mechanism at the side is mismatched with a connecting mechanism at the other side. During mold closing, the wear of the connecting mechanism between the molds will be caused, and the service life of the mold is shortened.

In order to solve the foregoing problem, an adjustable support positioning mechanism is disclosed in the related art, such as a mold plate support guide device disclosed in Chinese Patent No. 201510439127, which includes a rack guide rail arranged in the horizontal direction, where both the top surface and the side surface are provided with support adjusting modules urged through grooves. The support adjusting module includes a first wedge block in slide matching with the rack rail, and a second wedge block fixedly connected with a mold plate support leg, an intermediate block is urged between the first wedge block and the second wedge block, and the support adjusting module is provided with an adjusting component for adjusting the distance between the bottom surface of the first wedge block and the top surface of the second wedge block. The movable mold plate can be adjusted by the support adjusting module in three directions so that the mold plate can be stably and precisely placed on the rack guide rail, thus reducing the requirements of machining accuracy of the rack and the mold plate.

However, in the above-mentioned adjusting component, a connecting shaft is in threaded connection with the intermediate block, manual adjustment is needed and a device for measuring or displaying the height of the movable mold base in real time is not provided. After the support device is worn due to the long-term reciprocating movement on the guide rail, the height of the movable mold base needs to be manually measured and adjusted, thereby increasing the labor intensity.

Therefore, it is necessary to design a novel injection molding machine device and a pneumatic support mechanism, so as to solve the foregoing problem.

### SUMMARY OF THE INVENTION

In one aspect, the present invention relates to an injection molding machine device and a pneumatic support mechanism, where the height of a movable mold base in the vertical direction can be automatically adjusted by arranging the pneumatic support mechanism below the movable mold base of the injection molding machine device.

In certain embodiments, an injection molding machine device includes: a rack; at least one guide rail, fixed to the rack; at least two guide rods, both ends of each guide rod being fixedly arranged on the rack respectively; a fixed mold base, fixed to one end of the rack; a movable mold base, arranged opposite to the fixed mold base, and provided with at least two receiving holes corresponding to the receiving guide rods, where the movable mold base slides on the guide rods relative to the fixed mold base; and at least one pneumatic support mechanism. The at least one pneumatic support mechanism has a lower support plate positioned above the guide rail, an upper support plate fixed to the movable mold base and positioned above the lower support plate, at least one accommodating cavity arranged between the upper support plate and the lower support plate, and a cylinder correspondingly received in the accommodating cavity, where the movable mold base is adjusted by the cylinder through the upper support plate.

In certain embodiments, the accommodating cavity is arranged on the lower support plate, and the upper support plate is positioned above the accommodating cavity.

In certain embodiments, a gasket is arranged between the cylinder and the upper support plate.

In certain embodiments, the number of the accommodating cavities is eight, and every two accommodating cavities are set as an accommodating cavity group. In the width direction of the lower support plate, the distances between the two accommodating cavities in each accommodating cavity group and the first side wall of the lower support plate are equal, and the distance between a first accommodating cavity group and the first side wall is smaller than the distance between a second accommodating cavity group and the first side wall. In the length direction of the lower support plate, the first accommodating cavity group is symmetrical to a third accommodating cavity group, and the second accommodating cavity group is symmetrical to a fourth accommodating cavity group.

In certain embodiments, an air vent is arranged between the two accommodating cavities in each accommodating cavity group, an air vent is arranged between the two adjacent accommodating cavities in the first accommodating cavity group and the second accommodating cavity group, and an air vent is arranged between the two adjacent accommodating cavities in the third accommodating cavity group and the fourth accommodating cavity group.

In certain embodiments, a first air inlet is formed in one end of the first side wall of the lower support plate and a second air inlet is formed in the other end of the first side wall of the lower support plate, the first air inlet is communicated with the leftmost accommodating cavity, and the second air inlet is communicated with the rightmost accommodating cavity.

In certain embodiments, a lever dial indicator is arranged below the movable mold base.

In another aspect, the present invention relates to a pneumatic support mechanism for supporting a movable mold base in an injection molding machine, making a reciprocating movement on the guide rail along with the movable mold base, and adjusting the height of the movable mold base in the vertical direction. In certain embodiments, the pneumatic support mechanism includes an upper support plate and a lower support plate installed below the upper support plate, and multiple cylinders. Two accommodating cavity groups are arranged at each of the left and right sides of the lower support plate. Each accommodating cavity group includes two accommodating cavities. An air vent is arranged between the two accommodating cavities in each accommodating cavity group. A first air inlet and a second air inlet are respectively formed in the left and right sides of the first side wall of the lower support plate. The first air inlet is communicated with the leftmost accommodating cavity of the lower support plate, and the second air inlet is communicated with the rightmost accommodating cavity of the lower support plate. The cylinders respectively and correspondingly received in multiple accommodating cavities.

In certain embodiments, a gasket is arranged between each cylinder and the upper support plate.

In certain embodiments, the distances between the two accommodating cavities in each accommodating cavity group and the first side wall are equal, and the distance between a first accommodating cavity group and the first side wall is smaller than the distance between a second accommodating cavity group and the first side wall. In the length direction of the lower support plate, the first accommodating cavity group is symmetrical to a third accommodating cavity group, and the second accommodating cavity group is symmetrical to a fourth accommodating cavity group.

Compared with the related art, the injection molding machine and the pneumatic support mechanism according to certain embodiments of the present invention, among other things, have the following beneficial advantages:

By arranging the pneumatic support mechanism below the movable mold base of the injection molding machine device, the movable mold base is supported, so that the effect of the weight of the movable mold base on the guide rods is reduced, and the height of the movable mold base in the vertical direction is automatically adjusted.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention.

Wherever possible, the same reference numbers are used throughout the drawings to refer to the same or like elements of an embodiment.

FIG. 1 is a schematic three-dimensional exploded view of an injection molding machine device according to one embodiment of the present invention.

FIG. 2 is a schematic three-dimensional view of an injection molding machine device according to one embodiment of the present invention.

FIG. 3 is a schematic three-dimensional exploded view of a pneumatic support mechanism according to one embodiment of the present invention.

FIG. 4 is a schematic three-dimensional exploded view of a pneumatic support mechanism viewed from another angle according to one embodiment of the present invention.

FIG. 5 is a schematic component view of a pneumatic support mechanism according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

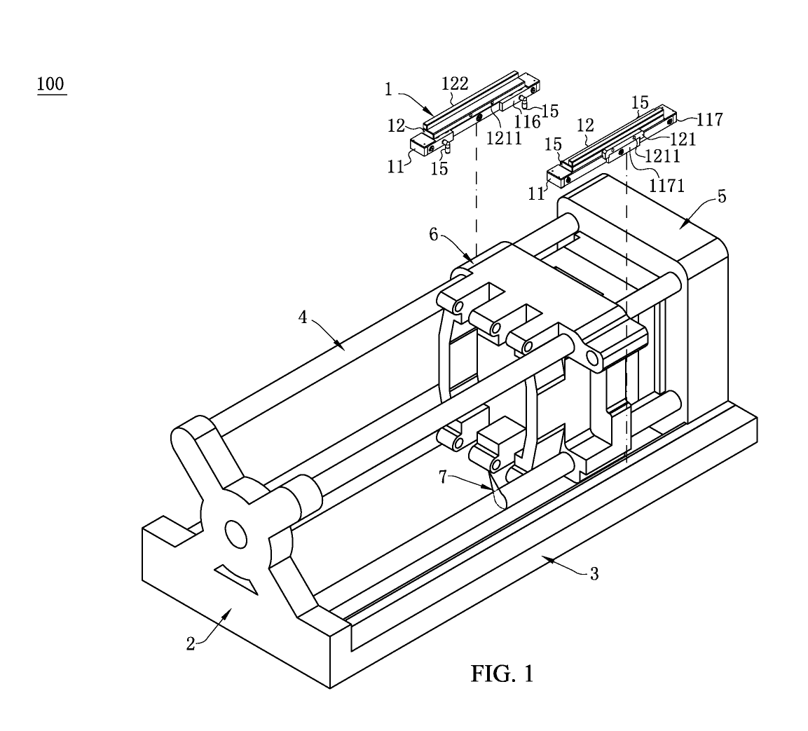

The description will be made as to the embodiments of the present invention in conjunction with the accompanying drawings in FIGS. 1-5. In accordance with the purposes of this invention, as embodied and broadly described herein, this invention, in one aspect, relates toan injection molding machine.

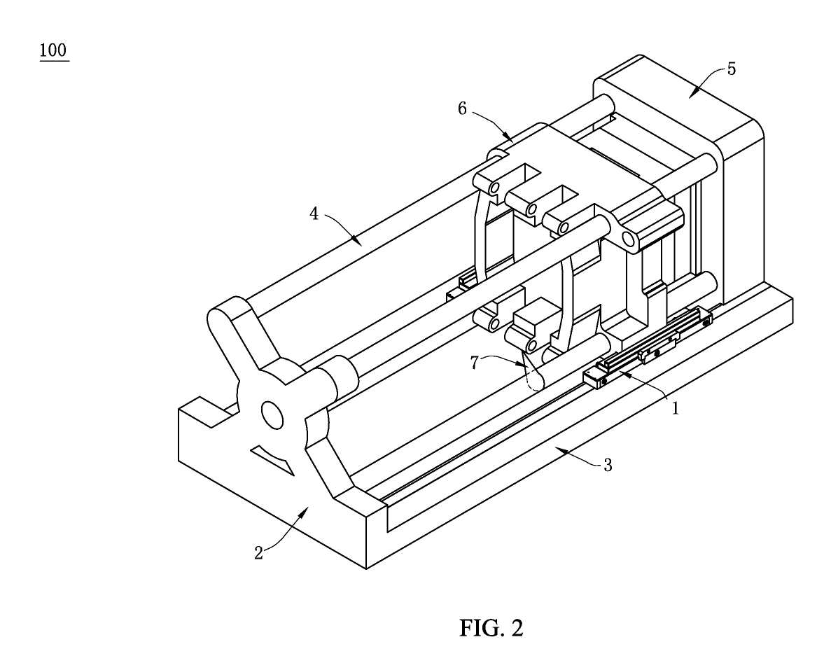

As shown in FIGS. 1 and 2, an injection molding machine device 100 according to one embodiment of the present invention includes a rack 2, two guide rails 3, four guide rods 4, a fixed mold base 5, a movable mold base 6, and two pneumatic support mechanisms. The two guide rails 3 are horizontally arranged opposite to each other. In certain embodiments, the number of the guide rails 3 may be one. The adjacent two guide rods 4 are arranged opposite to each other, and the two ends of each guide rod 4 are respectively fixed to the rack 2. In certain embodiments, the number of the guide rods 4 may be two or three. The fixed mold base 5 is fixed to the right end of the rack 2. The movable mold base 6 is arranged opposite to the fixed mold base 5. Four receiving holes corresponding to the guide rods 4 are arranged around the fixed mold base 5. In certain embodiments, the number of the receiving holes corresponds to the number of the guide rods 4, and may be two or three. The movable mold base 6 slides back and forth on the guide rods 4 relative to the fixed mold base 5 under the action of a driving mechanism (not shown) to realize mold closing and opening. The two pneumatic support mechanisms are fixed to the movable mold base 6 and positioned below the movable mold base 6 and above the guide rails 3 to support the weight of the movable mold base 6, and move back and forth on the horizontal guide rails 3 along with the movable mold base 6 to reduce the effect of the gravity of the movable mold base 6 on the guide rods 4. In certain embodiments, the number of the pneumatic support mechanisms may be one or another number.

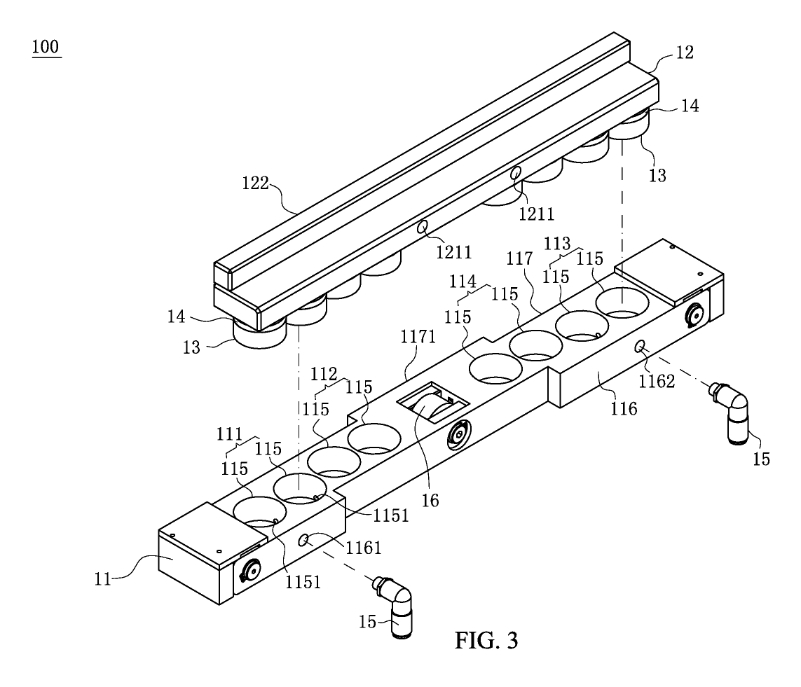

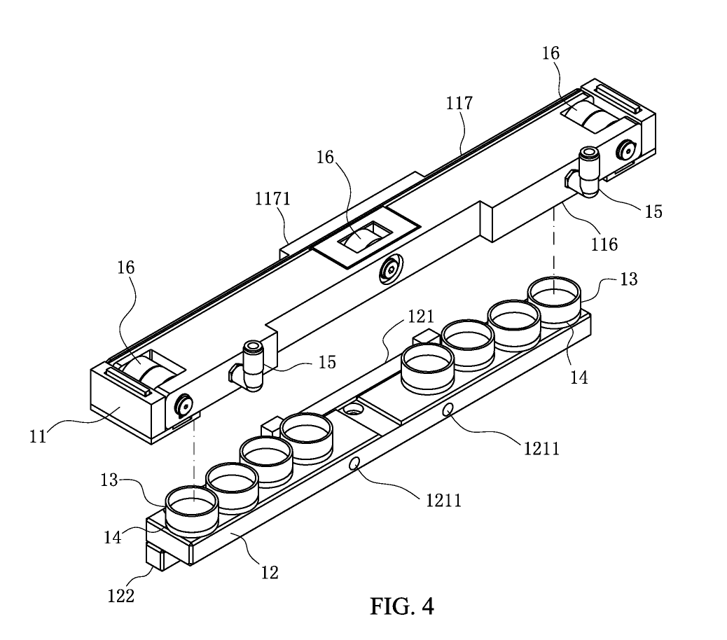

As shown in FIGS. 3 and 4, the pneumatic support mechanism has an upper support plate 12 fixed to the movable mold base 6, and a lower support plate 11 positioned above the guide rails 3 and below the upper support plate 12. Multiple accommodating cavities 115 are arranged on the lower support plate 11 for respectively receiving multiple cylinders 13 inside, and the movable mold base 6 is adjusted by the upper support plate 12. In certain embodiments, the accommodating cavities 115 may also be arranged on the upper support plate 12 or between the upper support plate 12 and the lower support plate 11.

As shown in FIGS. 3 and 4, the upper support plate 12 is positioned above the accommodating cavities 115. One side wall of the upper support plate 12 is provided with a fastening portion 121. The side wall of the fastening portion 121 is provided with two through holes 1211 for receiving a fixing member (not shown) for fixing the upper support plate 12 and the movable mold base 6. An attached plate 122 is fixed on the upper surface of the upper support plate 12, and can cover and protect the bottom side of the side wall of the movable mold base 6.

As shown in FIGS. 3-5, a protruding portion 1171 corresponding to the fastening portion 121 is arranged on the second side wall 117 of the lower support plate 11. The protruding portion 1171 matches with the fastening portion 121. The number of the accommodating cavities 115 is eight. Every two adjacent accommodating cavities 115 are set as an accommodating cavity group. In the width direction of the lower support plate 11, the distances between the two accommodating cavities 115 in each accommodating cavity group and the first side wall 116 of the lower support plate 11 are equal. The distance D1 between a first accommodating cavity group 111 and the first side wall 116 is smaller than the distance D2 between a second accommodating cavity group 112 and the first side wall 116. In the length direction of the lower support plate 11, the first accommodating cavity group 111 is symmetrical to a third accommodating cavity group 113, and the second accommodating cavity group 112 is symmetrical to a fourth accommodating cavity group 114. The number of cylinders 13 is eight. Each of the eight cylinders 13 is fixedly installed in corresponding one of the accommodating cavities 115. When the cylinders 13 are driven to adjust the height of the movable mold base 6 in the vertical direction, the symmetrically arranged cylinders 13 can ensure that the movable mold base 6 bears force evenly.

As shown in FIGS. 3 and 4, a gasket 14 is disposed between each cylinder 13 and the upper support plate 12 to prevent the cylinder 13 from being in direct contact with the upper support plate 12 to wear, thereby prolonging the service life of the cylinders 13.

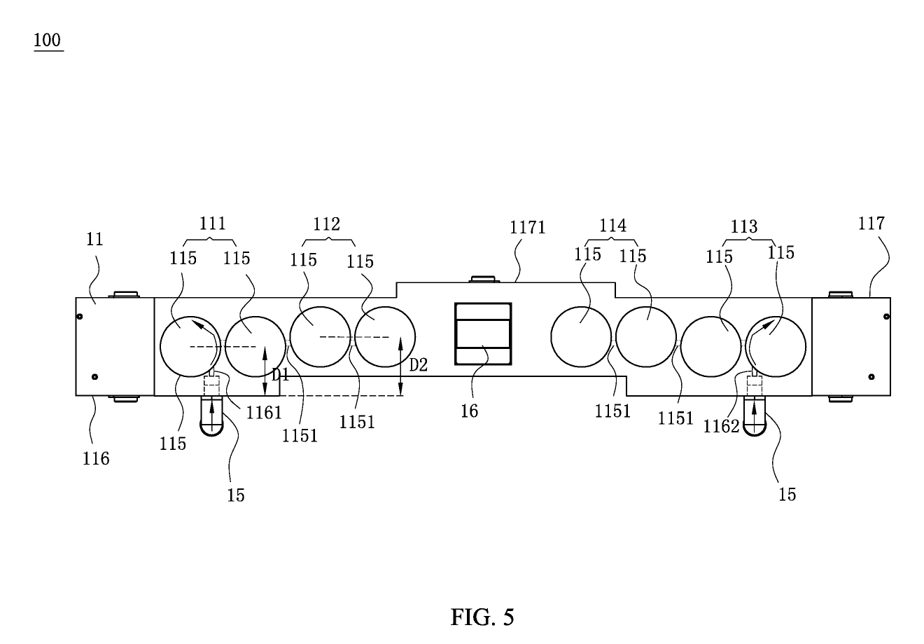

As shown in FIGS. 3 and 5, an air vent 1151 is formed between the two accommodating cavities 115 in each accommodating cavity group, an air vent 1151 is arranged between the two adjacent accommodating cavities 115 in the first accommodating cavity group 111 and the second accommodating cavity group 112, and an air vent 1151 is arranged between the two adjacent accommodating cavities 115 in the third accommodating cavity group 113 and the fourth accommodating cavity group 114. A first air inlet 1161 and a second air inlet 1162 are respectively formed in the left and right sides of the first side wall 116 of the lower support plate 11. The first air inlet 1161 is in communication with the leftmost accommodating cavity 115 of the lower support plate 11, and the second air inlet 1162 is in communication with the rightmost accommodating cavity 115 of the lower support plate 11. The air pressure supply to the four cylinders 13 at the left side of the lower support plate 11 is realized by the first air inlet 1161 and the air vents 1151 in the first accommodating cavity group 111 and the second accommodating cavity group 112, and the air pressure supply to the four cylinders 13 at the right side of the lower support plate 11 is realized by the second air inlet 1162 and the air vents 1151 in the third accommodating cavity group 113 and the fourth accommodating cavity group 114.

As shown in FIGS. 3-5, rolling bearings 16 are respectively arranged at the two sides and in the middle of the lower support plate 11, and the rolling bearings 16 roll on the upper surfaces of the guide rails 3 to reduce the resistance of the pneumatic support mechanisms during moving back and forth on the guide rails 3. In certain embodiments, roller wheels or other rolling members may be installed instead of the rolling bearings 16.

As shown in FIGS. 1 and 2, a lever dial indicator 7 is disposed below the movable mold base 6. When the height of the movable mold base 6 in the vertical direction is adjusted by air pressure, the lever dial indicator 7 can detect the height of the movable mold base 6 so as to control the air inlet amount and adjust the movable mold base 6 to a suitable height. In certain embodiments, other instruments for detecting the height may be disposed instead of the lever dial indicator 7.

As shown in FIGS. 3-5, the first air inlet 1161 and the second air inlet 1162 respectively receive an air inlet pipe 15. A pneumatic check valve (not shown) is disposed at the other air inlet end of the air inlet pipe 15 so as to prevent the height of the movable mold base 6 from being decreased due to a decrease in the air pressure in the cylinder 13, thereby stabilizing the height of the movable mold holder 6 and ensuring the accuracy of an injection molded product.

In summary, the injection molding machine device 100 and the pneumatic support mechanism according to certain embodiments of the present invention, among other things, have the following beneficial advantages:

(1) The pneumatic support mechanisms are arranged below the movable mold base 6, and the vertical height of the movable mold base 6 in the vertical direction can be automatically adjusted by the air pressure driving.

(2) The gasket 14 is arranged between the cylinder 13 and the upper support plate 12 to prevent the cylinder 13 from being in direct contact with the upper support plate 12 to wear, thereby prolonging the service life of the cylinder 13.

(3) The lever dial indicator 7 is arranged below the movable mold base 6. When the vertical height of the movable mold base 6 is adjusted, the lever dial indicator 7 can detect the height of the movable mold base 6 and detect whether the air pressure is reasonable or not so as to control the air inlet amount and adjust the movable mold base 6 to a suitable height.

(4) The pneumatic check valve is arranged at the air inlet end of the air inlet pipe 15 so as to prevent the height of the movable mold base 6 from being decreased due to a decrease in the air pressure in the cylinder 13, thereby stabilizing the height of the movable mold base 6 and ensuring the accuracy of the injection molded product.

The above detailed description only describes preferable embodiments of the present invention, and is not intended to limit the patent scope of the present invention, so any equivalent technical changes made by use of the specification of the creation and the content shown in the drawings fall within the patent scope of the present invention.

What is claimed is:

1. An injection molding machine device, comprising:
a rack;
at least one guide rail fixed to the rack;
at least two guide rods, both ends of each of the at least two guide rods being respectively fixed to the rack;
a fixed mold base fixed to one end of the rack;
a movable mold base arranged opposite to the fixed mold base, wherein the movable mold base is provided with at least two receiving holes for respectively receiving the at least two guide rods, and the movable mold base slides on the at least two guide rods relative to the fixed mold base; and
at least one pneumatic support mechanism, comprising:
a lower support plate positioned above the guide rail;
an upper support plate fixed to the movable mold base and positioned above the lower support plate;
at least one accommodating cavity arranged between the upper support plate and the lower support plate; and
a cylinder correspondingly received in the accommodating cavity, and configured to adjust the movable mold base through the upper support plate.

2. The injection molding machine device of claim 1, wherein the accommodating cavity is arranged on the lower support plate, and the upper support plate is positioned above the accommodating cavity.

3. The injection molding machine device of claim 1, further comprising a gasket disposed between the cylinder and the upper support plate.

4. The injection molding machine device of claim 2,
wherein a number of the accommodating cavities is eight, and every two accommodating cavities are set as an accommodating cavity group;
wherein in a width direction of the lower support plate, a distances between the two accommodating cavities in each accommodating cavity group and the first side wall of the lower support plate are equal, and a distance between a first accommodating cavity group and the first side wall is smaller than a distance between a second accommodating cavity group and the first side wall; and
wherein in a length direction of the lower support plate, the first accommodating cavity group is symmetrical to a third accommodating cavity group, and the second accommodating cavity group is symmetrical to a fourth accommodating cavity group.

5. The injection molding machine device of claim 4, wherein an air vent is arranged between the two accommodating cavities in each accommodating cavity group, an air vent is arranged between the two adjacent accommodating cavities in the first accommodating cavity group and the second accommodating cavity group, and an air vent is arranged between the two adjacent accommodating cavities in the third accommodating cavity group and the fourth accommodating cavity group.

6. The injection molding machine device of claim 4, wherein a first air inlet is formed in one end of the first side wall of the lower support plate and a second air inlet is formed in the other end of the first side wall of the lower support plate, the first air inlet is in communication with the leftmost accommodating cavity, and the second air inlet is in communication with the rightmost accommodating cavity.

7. The injection molding machine device of claim 1, further comprising a lever dial indicator disposed below the movable mold base.

8. A pneumatic support mechanism for supporting a movable mold base in an injection molding machine, making a reciprocating movement on the guide rail along with the movable mold base, and adjusting the height of the movable mold base in the vertical direction, the pneumatic support mechanism comprising:
an upper support plate;
a lower support plate disposed below the upper support plate, wherein two accommodating cavity groups are arranged at each of a left side and a right side of the lower support plate, each accommodating cavity group includes two accommodating cavities, an air vent is arranged between the two accommodating cavities in each accommodating cavity group, a first air inlet and a second air inlet are respectively formed in a left side and a right side of a first side wall of the lower support plate, the first air inlet is in communication with a leftmost accommodating cavity of the lower support plate, and the second air inlet is in communication with a rightmost accommodating cavity of the lower support plate; and
a plurality of cylinders respectively received in the accommodating cavities.

9. The pneumatic support mechanism of claim 8, further comprising a gasket between each of the cylinders and the upper support plate.

10. The pneumatic support mechanism of claim 8, wherein distances between the two accommodating cavities in each accommodating cavity group and the first side wall are equal, and the distance between a first accommodating cavity group and the first side wall is smaller than the distance between a second accommodating cavity group and the first side wall; in a length direction of the lower support plate, the first accommodating cavity group is symmetrical to a third accommodating cavity group, and the second accommodating cavity group is symmetrical to a fourth accommodating cavity group.
